(19) United States
(12) Patent Application Publication
(10) Pub. No.: US 2007/0137456 A1
(43) Pub. Date: Jun. 21, 2007

(54) Vertical saw machine

(76) Inventor: Hui-Chuan Liao, Ta-Li City (TW)

Correspondence Address: TROP PRUNER & HU, PC, 1616 S. VOSS ROAD, SUITE 750, HOUSTON, TX, 77057-2631, US

(21) Appl. No.: 11/316,023

(22) Filed: Dec. 21, 2005

(51) Int. Cl. B23D 55/00

(52) U.S. Cl. 83/788; 83/809

(57) ABSTRACT

A vertical saw machine includes a column with upper and lower supports carrying a motor to drive a saw blade. A table is disposed between the upper and lower supports for supporting a workpiece thereon. The saw blade intersects the table with an included angle. The column is turnable between normal and inclined positions to vary the included angle. A frame post is mounted under the table to be positioned on the ground surface An arcuate key slot is formed in the frame post such that the motor projects through the key slot to be guided therealong so as to retainingly turn the column between the two positions -A worm gearing mechanism includes a worm wheel segment and a worm that are respectively mounted to the column and the frame post and that are operable to turn the column.

### BACKGROUND OF THE INVENTION

1. Field of the Invention

This invention relates to a vertical saw machine, more particularly to a vertical saw machine with a column which is turnable between normal and inclined positions for adjusting an angle of the column relative to a table.

2. Description of the Related Art

Referring to FIGS. 1 and 2, a conventional vertical band saw machine 1 is shown to include a column 11 with upper and lower supports 111, 112 which are spaced apart from each other to confine a working space 113 therebetween. A table 13 includes a horizontal support wall for supporting a workpiece (not shown), and extends into the working space 113. An endless band saw blade 12 is trained on two blade mounting pulleys (not shown) mounted on the upper and lower supports 111,112 so as to form an endless route, and has a front segment which intersects the horizontal support wall of the table 13 and which forms an included angle therewith. An adjustment member 131 is operable for adjusting the included angle as desired so as to adjust an angle of the workpiece supported on the horizontal support wall relative to the front segment of the saw blade 12. However, in such an arrangement, the workpiece supported on the table 13 may slide down the table when the latter is tilted during the sawing operation so that the operator needs to steady the workpiece, which is inconvenient.

### SUMMARY OF THE INVENTION

The object of the present invention is to provide a vertical saw machine in which an included angle of a saw blade relative to a table can be adjusted without the need to tilt the table.

According to this invention, the vertical saw machine comprises a column including a rear body which has upper and lower ends opposite to each other in a longitudinal direction, and upper and lower supports which extend forwardly and respectively from the upper and lower ends and in a first direction transverse to the longitudinal direction, and which are spaced apart from each other in the longitudinal direction to confine a working space therebetween. A motor is mounted on the lower support, and has an output shaft to deliver a drive force. A saw blade is driven by the drive force of the output shaft, and has a sawing portion which runs along a running route that extends from the upper support to the lower support and that is spaced apart from the rear body in the first direction. A table includes a horizontal support wall which is adapted to support a workpiece thereon and which extends into the working space. The table is mounted relative to the column such that the sawing portion intersects the horizontal support wall with an included angle facing towards the rear body, and at a centerline which is oriented in a second direction that is transverse to both the longitudinal direction and the first direction, and such that the column is turnable about the centerline between a normal position, where the included angle is 90 degrees, and an inclined position, where the included angle is an obtuse or acute angle. A frame post includes a bottom end positioned on a ground surface, and a major mounting wall extending from the bottom end in an upright direction which is parallel to the longitudinal direction when the column is in the normal position, and terminating at an upper end which is proximate to the horizontal support wall. The major mounting wall has a key slot which extends therethrough in the second direction, and which is configured to define a guiding route that is arcuate about the centerline. The motor extends in the second direction, and projects through the key slot to retainingly move along the guiding route and between first and second points which correspond to the normal and inclined positions, respectively. A worm gearing mechanism includes a worm wheel segment and a worm. The worm wheel segment is secured to the lower support, and includes a teeth portion that extends to be arcuate about the centerline. The worm is disposed to be rotatable relative to the major mounting wall about a rotating axis substantially in the first direction, and meshes with the teeth portion such that rotation of the worm about the rotating axis will bring the worm wheel segment to turn about the centerline such that the motor is moved between the first and second points, thereby turning the column between the normal and inclined positions.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional vertical band saw machine;

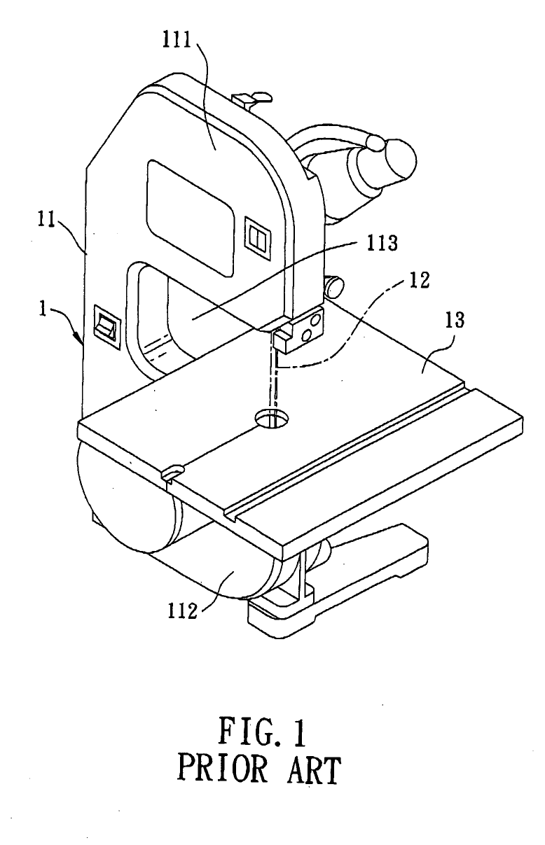

FIG. 2 is a schematic view of a table of the conventional vertical band saw machine in an inclined state;

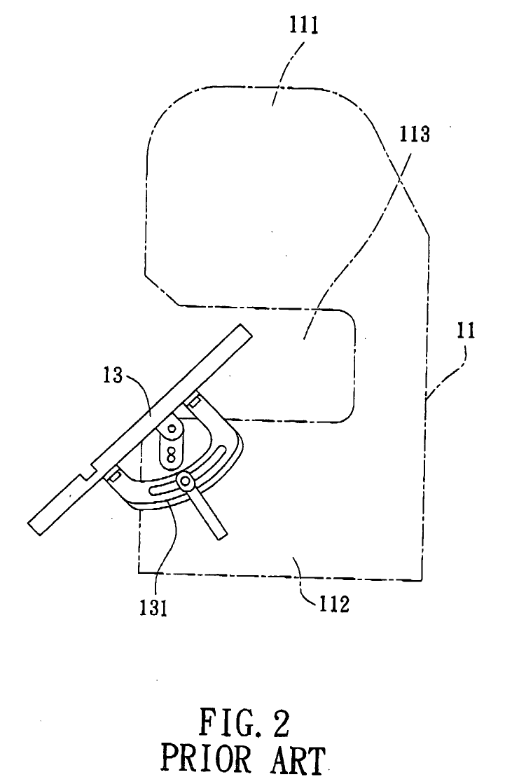

FIG. 3 is a perspective view of a preferred embodiment of a vertical saw machine according to this invention;

FIG. 4 is a side schematic view showing a blade mounting pulley assembly and a band saw blade mounted on a column of the preferred embodiment;

FIG. 5 is a side view of the preferred embodiment when the column is in a normal position; and

FIG. 6 is a side view of the preferred embodiment when the column is in an inclined position.

### DETAILED DESCRIPTION OF THE PREFERRED EMBODIMENT

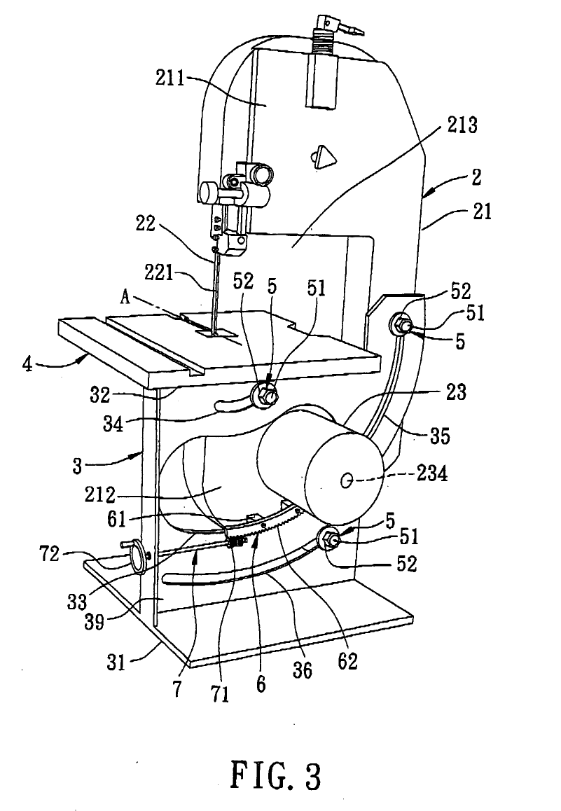

Referring to FIGS. 3 to 6, the preferred embodiment of a vertical saw machine according to the present invention is shown to comprise a column 2, a motor 23, an endless band saw blade 22, a table 4, a frame post 3, a worm gearing mechanism, and a plurality of fastening units 5. In this embodiment, the vertical saw machine is exemplified as a vertical band saw machine.

The column 2 includes a rear body 21 which has upper and lower ends opposite to each other in a longitudinal direction, and upper and lower supports 211,212 which extend forwardly and respectively from the upper and lower ends of the rear body 21 in a first direction transverse to the longitudinal direction, and which are spaced apart from each other in the longitudinal direction to define a working space 213 therebetween.

The motor 23 is secured on and extends from the lower support 212 in a second direction that is transverse to both the longitudinal and first directions, and has an output shaft 234 to deliver a drive force. Upper and lower blade mounting pulleys 231,232 are disposed respectively on and rotatable relative to the upper and lower supports 211, 212 about pulley axes which are oriented in the second direction, and are driven by the drive force of the output shaft 234 of the motor 23.

The endless band saw blade 22 is trained on the upper and lower blade mounting pulleys 231,232 so as to be driven by the drive force of the output shaft 234 of the motor 23 to run, along the lower support 212, the rear body 21 and the upper support 211 in sequence, and then along a front running route which interconnects the upper and lower supports 211,212, thereby forming an endless route. The saw blade 22 has a front sawing portion 221 which runs along the front running route.

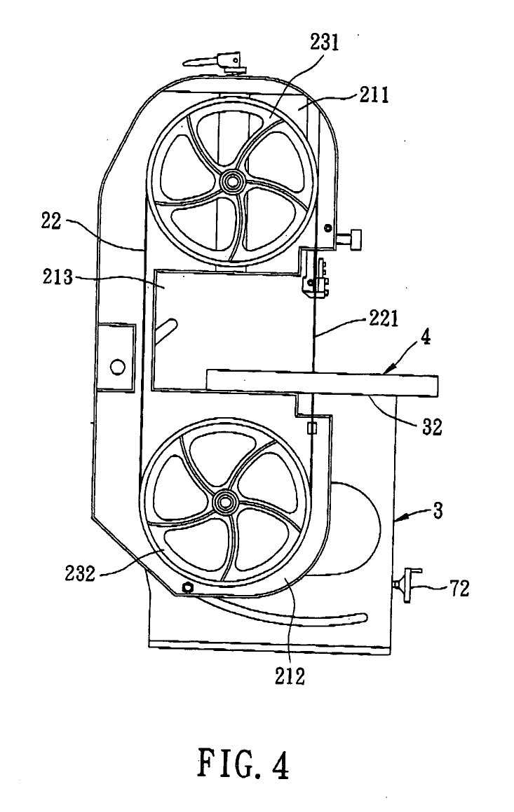

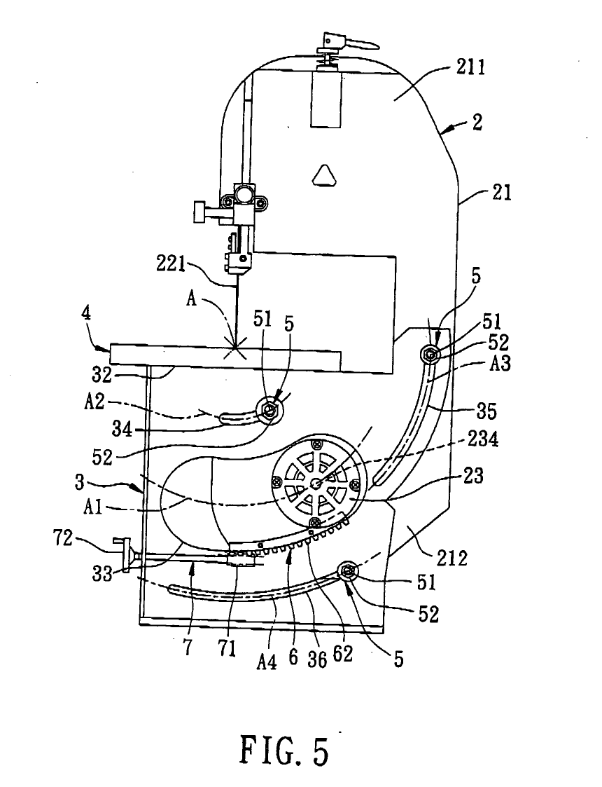

A table 4 includes a horizontal support wall which is adapted to support a workpiece (not shown) thereon, and which extends into the working space 213. The table 4 is mounted relative to the column 2 such that the front sawing portion 221 of the saw blade 22 intersects the horizontal support wall with an included angle facing towards the rear body 21, and at a centerline (A) which is parallel to the first axis. In addition, the column 2 is turnable about the centerline (A) between a normal position, as shown in FIG. 4, where the included angle is 90 degrees, and an inclined position, as shown in FIG. 5, where the included angle is an obtuse or acute angle.

A frame post 3 includes a bottom end 31 to be positioned on a ground surface, and a major mounting wall 39 which extends from the bottom end 31 in an upright direction that is parallel to the longitudinal direction when the column 2 is in the normal position, and which terminates at an upper end 32 which is secured on the horizontal support wall of the table 4. The major mounting wall 39 has a key slot 33 and three locking slots 34,35,36 which extend therethrough in the second direction, and which are arcuate about the centerline (A) to define guiding routes A1, A2, A3, A4, respectively. The motor 23 projects through the key slot 33 to retainingly move along the guiding route Al and between first and second points that correspond to the normal and inclined positions, respectively.

The worm gearing mechanism includes a worm wheel segment 6, and a worm 71. The worm wheel segment 6 is secured to the lower support 212 by means of a pair of mounts 61, and includes a teeth portion 62 that extends to be arcuate about the centerline (A). The mounts 61 extend in the second direction through the key slot 33 such that the worm wheel segment 6 extends outwardly of the key slot 33, and are disposed to be movable along the guiding route A1. The worm 71 is connected to an end of an operating shaft 7 to be rotatable relative to the major mounting wall 39 about a rotating axis substantially in the first direction, and meshes with the teeth portion 62 of the worm wheel segment 6 such that rotation of the worm 71 about the rotating axis will bring the worm wheel segment 6 to turn about the centerline (A) and such that the motor 23 is moved between the first and second points, thereby turning the column 2 between the normal and inclined positions. The operating shaft 7 further has an opposite end 72 which extends outwardly of the major mounting wall 39 and which is to be operable to rotate the worm 71.

Each of the fastening units 5 includes a shank 51 which has a secured segment that is secured to the lower support 212, and which extends through a respective one of the locking slots 34, 35, 36 to terminate at a threaded segment, and a screw nut 52 which is disposed to threadedly engage the threaded segment of the shank 51 so as to fasten the major mounting wall 39 to the lower support 212 to thereby lock the column 2 in one of the normal and inclined positions.

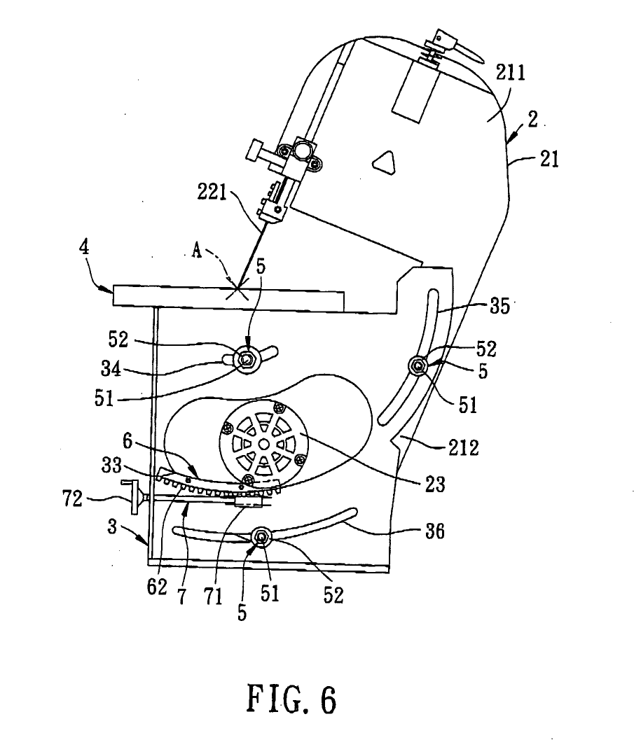

As shown in FIGS. 5 and 6, when the operating shaft 7 is operated to rotate the worm 71 after the fastening units 5 are loosened, the worm wheel segment 6 is driven to turn about the centerline (A) so as to move the motor 23 and the shanks 51 along the guiding routes A1, A2, A3, A4, respectively, thereby turning the column 2 to a desired inclined position relative to the table 4. Hence, the angle of the sawing portion 221 of the saw blade 22 relative to a workpiece on the horizontal support wall of the table 4 can be adjusted. It is noted that as the column 2 can be retained in position by meshing engagement of the teeth portion 62 and the worm 71, the adjustment operation is convenient, safe, and effortless.

Although the invention has been illustrated using a vertical band saw machine as an example, it is noted that the invention is not limited thereto, and covers any powered sawing machine that has a saw blade capable of reciprocating motion in an upright direction, such as a scroll saw machine.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A vertical saw machine comprising:
a column including a rear body which has upper and lower ends opposite to each other in a longitudinal direction, and upper and lower supports which extend forwardly and respectively from said upper and lower ends in a first direction transverse to the longitudinal direction, and which are spaced apart from each other in the longitudinal direction to confine a working space therebetween;
a motor mounted on said lower support, and having an output shaft to deliver a drive force;
a saw blade driven by the drive force of said output shaft, and having a sawing portion which runs along a running route that extends from said upper support to said lower support and that is spaced apart from said rear body in the first direction;
a table including a horizontal support wall which is adapted to support a workpiece thereon and which extends into said working space, said table being mounted relative to said column such that said sawing portion intersects said horizontal support wall with an included angle facing towards said rear body, and at a centerline which is oriented in a second direction that is transverse to both the longitudinal direction and the first direction, and such that said column is turnable about the centerline between a normal position, where the included angle is 90 degrees, and an inclined position, where the included angle is an obtuse or acute angle;
a frame post including a bottom end positioned on a ground surface, and a major mounting wall extending from said bottom end in an upright direction which is parallel to the longitudinal direction when said column is in the normal position, and terminating at an upper end which is proximate to said horizontal support wall, said major mounting wall having a key slot which extends therethrough in the second direction, and which is configured to define a guiding route that is arcuate about the centerline;
said motor extending in the second direction, and projecting through said key slot to retainingly move along said guiding route and between first and second points which correspond to the normal and inclined positions, respectively; and
a worm gearing mechanism including
a worm wheel segment secured to said lower support, and including a teeth portion that extends to be arcuate about the centerline, and
a worm which is disposed to be rotatable relative to said major mounting wall about a rotating axis substantially in the first direction, and which meshes with said teeth portion such that rotation of said worm about the rotating axis will bring said worm wheel segment to turn about the centerline such that said motor is moved between the first and second points, thereby turning said column between the normal and inclined positions.

2. The vertical saw machine of claim 1, further comprising a pair of mounts which are disposed to interconnect said lower support and said worm wheel segment and which extend in the second direction through said key slot such that said worm wheel segment is disposed outwardly of said key slot.

3. The vertical saw machine of claim 2, wherein said mounts are disposed to be movable along said guiding route during rotation of said worm.

4. The vertical saw machine of claim 1, further comprising an operating shaft having an end which is connected to said worm, and an opposite end which extends outwardly of said major mounting wall and which is operable to rotate said worm.

5. The vertical saw machine of claim 1, wherein said major mounting wall has a plurality of locking slots which extend therethrough in the second direction, and which are arcuate about the centerline, said vertical saw machine further comprising a plurality of fastening units, each including a shank which has a secured segment that is secured to said lower support, and which extends through a respective one of said locking slots to terminate at a threaded segment, and a screw nut which is disposed to threadedly engage said threaded segment so as to fasten said major mounting wall to said lower support to thereby lock said column in one of the normal and inclined positions.

6. The vertical saw machine of claim 1, further comprising a blade mounting pulley driven by the drive force of said output shaft, and disposed on and rotatable relative to said column about a first axis that is parallel to the centerline, wherein
said saw blade is an endless band saw blade trained on said blade mounting pulley so as to run along said lower support, said rear body and said upper support in sequence, and then along said running route, thereby forming an endless route.
